(19) United States
(12) Patent Application Publication
(10) Pub. No.: US 2007/0295706 A1
(43) Pub. Date: Dec. 27, 2007

(54) Electrical Heating Arrangement, Especially for a Motor Vehicle

(75) Inventors: Michel Brun, Rustenhart (FR); Gerard Eckerlen, Rouffach (FR); Pascal Miss, Selestat (DE); Mathieu Mougey, Ensisheim (FR); Christophe Schmittheisler, Epfig (FR)

Correspondence Address: FOLEY AND LARDNER LLP;SUITE 500, 3000 K STREET NW, WASHINGTON, DC, 20007, US

(73) Assignee: BEHR FRANCE ROUFFACH SAS, F-68250 ROUFFACH, FRANCE (FR)

(21) Appl. No.: 11/664,517

(22) PCT Filed: Sep. 28, 2005
(86) PCT No.: PCT/EP05/10479

§ 371 Date: Apr. 3, 2007

(30) Foreign Application Priority Data
Oct. 4, 2004 (EP) 04292354.0

(51) Int. Cl. B60L 1/02

(52) U.S. Cl. 219/202

(57) ABSTRACT

The invention relates to an electrical heating arrangement, especially for a motor vehicle, said arrangement comprising an air channel housing (20) through which air to be heated flows as required, and an electrical heating clement (2) which is arranged in the air channel housing (20). The invention is characterised in that the electrical heating element (2) is arranged directly in the air channel housing (20).

The invention relates to an electrical heating arrangement, especially for a motor vehicle, according to the preamble of claim 1.

DE 101 44 757 A1 discloses a heating arrangement with a PTC element for passenger vehicles, interseasonal heating being provided with a heater, through which heating air flows when the interseasonal heating is in operation, and with at least one air outlet port, to which the heating air is conducted, in the foot region of a passenger space. So that a vertical temperature stratification can be generated in the passenger space in a flexible way and gives a pleasant feeling especially also on the seats at the back, the heater is configured as an electrical PTC element which is arranged directly at the air outlet port in the foot region. Such an interseasonal heater still leaves much to be desired. According to an exemplary embodiment, a PTC element in the form of a plurality of heating cells is arranged in a plastic frame, not described in any more detail, which surrounds the air outlet port.

DE 100 61 661 A1 discloses an electrically heatable grille which is arranged in an outflow port of a passenger space ventilation system, in which the air pretreated by heat exchangers is routed through various flow ducts to outflow ports in the driver's, front seat passenger's and back seat passenger's space. In the region of the grille, a temperature regulating device may be arranged, by means of which the temperature of the outflowing airstream is set. Furthermore, in the region of the grille, a temperature measuring device may be arranged, which measures the temperature of the outflowing airstream at the grille and/or in the passenger space. It may be positioned directly in or at the outflow port, so that a rapid feedback to the grille is possible. In this case, each grille may be activated separately, and activation may take place, inter alia, in that the temperature regulating device communicates directly with a temperature measuring device, so that the voltage and/or current intensity with which the grille is supplied can be set as a function of the difference between the temperature regulating device and temperature measuring device. The grille may also be a self-regulating PTC element not described in any more detail in DE 100 61 661 A1 in terms of its structural configuration.

The object of the invention is to make an improved electrical heating arrangement available.

This object is achieved by means of an electrical heating arrangement having the features of claim 1. Advantageous refinements are the subject matter of the subclaims.

According to the invention, an electrical heating arrangement is provided with an air duct housing, through which air to be heated flows as required, and with an electrical heating element which is arranged in the air duct housing, the electrical heating element being arranged directly in the air duct housing. In this case, the heating element of the heating arrangement is introduced directly, that is to say without a special frame, into the air duct housing, so that the production costs and also the recycling costs are markedly reduced.

Preferably, the air duct housing is designed in at least two parts as a plastic housing in the region in which the electrical heating element is arranged. A two-part design allows simple and rapid mounting, along with good strength properties. Furthermore, the air duct housing can be produced in a simple way by means of injection molding. The two housing parts are preferably connected to one another by means of snap connections and/or clips on the outside of the housing, so that no connection elements project into the inner space and influence the flow duct.

The two parts of the air duct housing are preferably designed asymmetrically, with the result that assembly errors can be avoided in a simple way. Furthermore, the positioning of the electrical heating element in a lower part designed to be larger can take place more simply and more accurately, so that, preferably, a U-shaped lower part and an upper part closing the latter and taking the form of a cover are provided.

For sealing off, preferably, a kind of tongue-and-groove connection is in each case formed on both sides between the two parts of the air duct housing. This allows some play in the event of different thermal expansions or other deformations and relatively high manufacturing tolerances, without leaks occurring between the housing parts.

The electrical heating element comprises at least one PTC element. In this case, preferably, contact plates which serve for electrical contacting are attached on both sides of the PTC element. The connection between the contact plates and PTC element takes place preferably by means of an adhesive connection.

To that side of the contact plate which faces away from the PTC element, preferably, a corrugated rib and, if appropriate, further contact plates, PTC elements and corrugated ribs are attached by means of adhesive connections which are preferably formed by a two-component silicone adhesive.

At least two contact plates are designed in such a way that they are designed at one end as part of a plug which, for electrical contacting, projects laterally beyond the surface with corrugated ribs which has air flowing through it. Preferably, in this case, at least one contact plate is designed to be Z-shaped in its end region which projects laterally beyond the corrugated rib.

Preferably, a connection piece with an insulating housing is arranged in the air duct housing.

Furthermore, to simplify mounting, the housing has formed on it at least one positioning element which resembles a guide groove and into which a slightly projecting wall region of the connection piece is introduced.

The housing preferably has an insulating partition which ensures that a short circuit between the contact plates, between which the PTC element is arranged, is avoided. Correspondingly, at least one spacer is preferably formed on the air duct housing and ensures that a short circuit between the contact plates, between which the PTC element is arranged, is avoided within the electrical heating element.

Preferably, a controller for the electrical activation of the electrical heating element is provided. This controller is preferably arranged laterally on the heating element.

In this case, the controller may preferably have a groove which serves for fixing the housing parts to one another, in that a rib-like projection provided on each of the housing parts is introduced into the groove. To make introduction easier, an introduction slope is preferably provided on a groove.

In order to cool the power electronics, a cooling plate is preferably provided on the controller and projects at least partially into the air duct housing, so that the air flowing in the latter flows around said cooling plate, the cooling plate being arranged upstream of or on that side of the heating element which faces the airstream, as seen in the air flow direction, thus ensuring that only cool air, not air heated by the heating element, flows around the cooling plate. The cooling plate preferably has cooling ribs for enlarging the heat transmission area.

In the air duct formed by the air duct housing, a temperature sensor is arranged preferably downstream of the heating element, and in this case the temperature sensor may be, for example, a thermocouple, but also any other temperature sensor. This ensures that the heating element is not overloaded by the generation of an excessive amount of heat.

The air duct housing preferably has on the housing upper part and/or lower part ribs which serve for air routing. In addition, these ribs, provided especially in the air outlet region, may serve as protection against foreign bodies which could otherwise pass into the air duct housing. The ribs are preferably distributed uniformly over the air outlet and are arranged essentially parallel to the housing sides.

In order to lift off the airstream from the floor on which the air duct housing is normally mounted, at least one ramp, which deflects the airstream upward, is formed preferably at the air outlet.

A simple and reliable fixing of the two-part air duct housing to the vehicle floor or the like by means of one or more screws is made possible by the provision of at least one shackle which is designed as a two-part, especially as a centrally divided ring, one part being formed by a correspondingly designed region of the housing lower part and the other part being formed by a correspondingly designed region of the housing upper part. The shackle is preferably provided centrally at the air outlet of the air duct housing.

The invention is explained in detail below by means of an exemplary embodiment with a variant, with reference to the drawing in which:

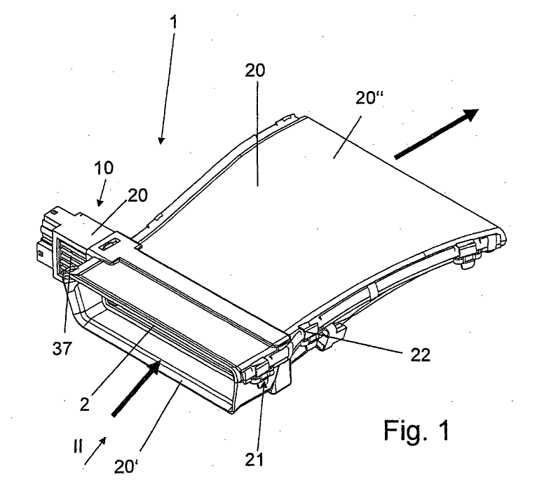

FIG. 1 shows a perspective view of a heating arrangement according to the invention,

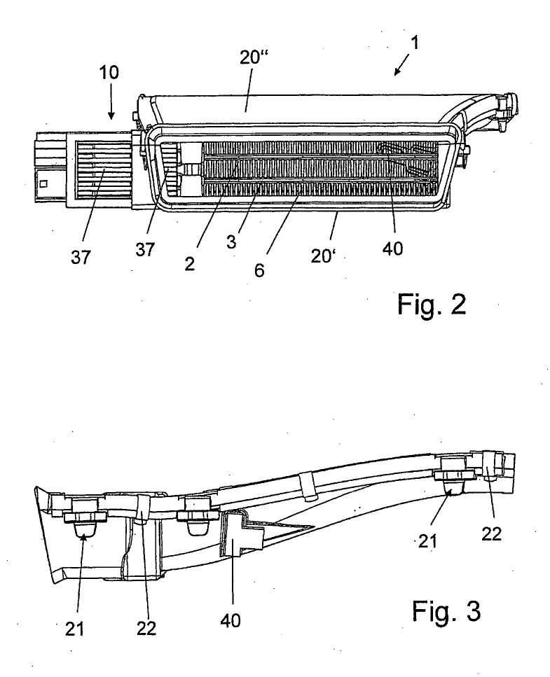

FIG. 2 shows a view of the heating arrangement of FIG. 1 in the direction of the arrow II of FIG. 1,

FIG. 3 shows the heating arrangement of FIG. 1 in a longitudinal section,

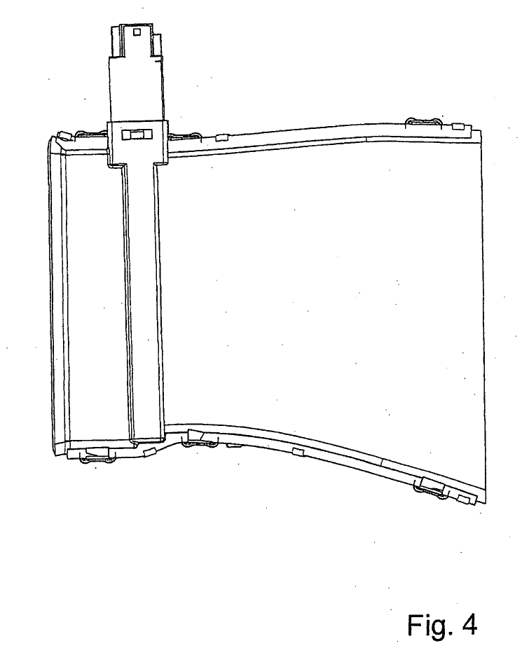

FIG. 4 shows a top view of the heating arrangement of FIG. 1,

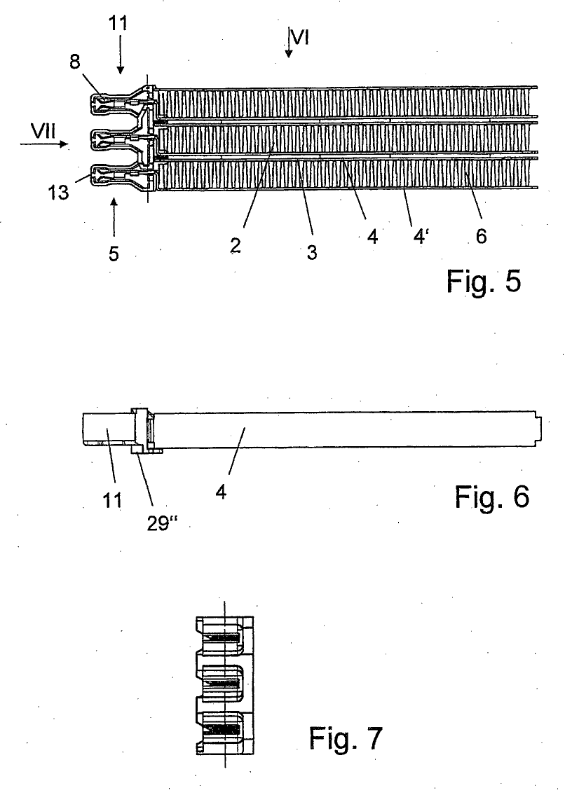

FIG. 5 shows an illustration of the electrical heating element which is arranged in the heating arrangement of FIG. 1,

FIG. 6 shows a side view of the heating element of FIG. 5 in the direction of the arrow VI of FIG. 5,

FIG. 7 shows a side view of a heating element of FIG. 5 in the direction of the arrow VII of FIG. 5,

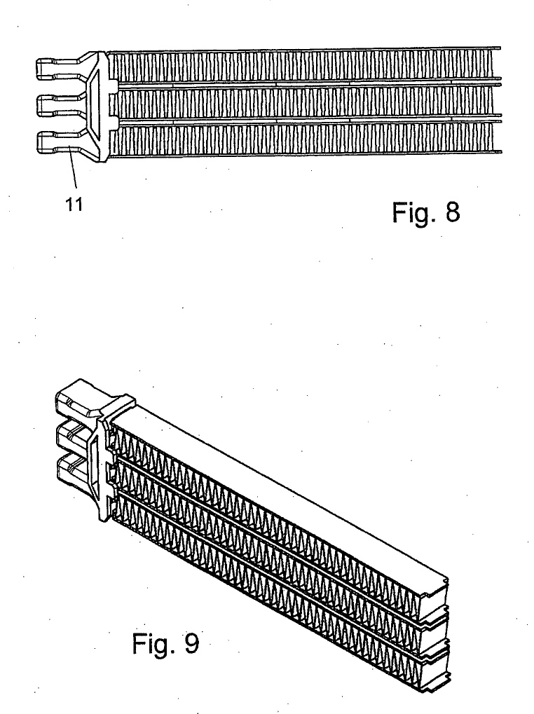

FIG. 8 shows a view of the heating element of FIG. 5 from below,

FIG. 9 shows a perspective view of the heating element of FIG. 5,

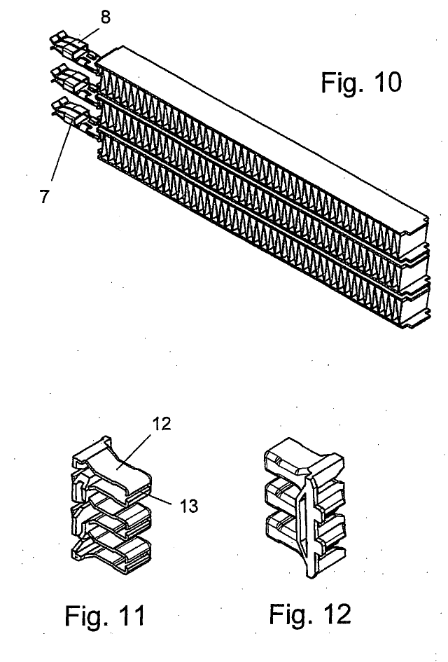

FIG. 10 shows a perspective view of the heating element according to FIG. 9, without an illustration of the connection piece,

FIG. 11 shows a perspective illustration of the connection piece,

FIG. 12 shows another perspective illustration of the connection piece,

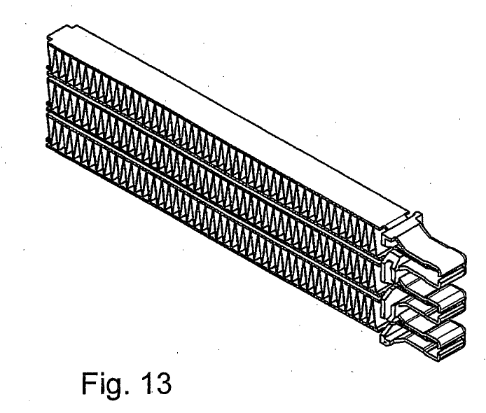

FIG. 13 shows a perspective illustration of the heating element with connection piece,

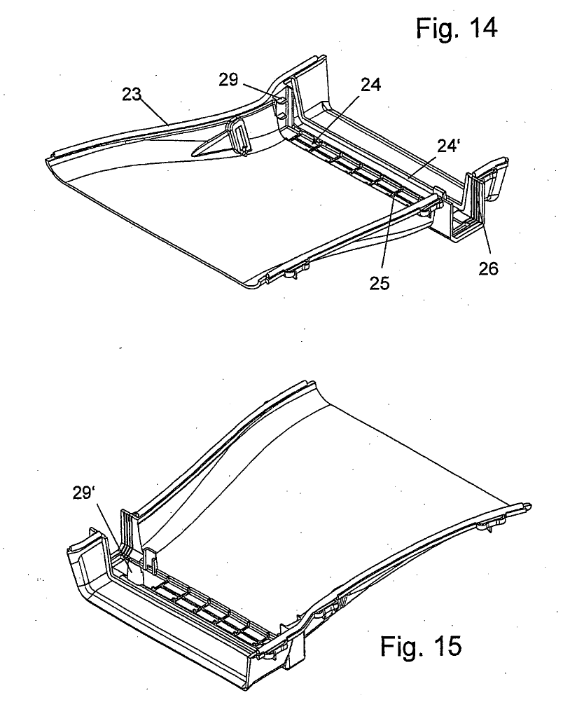

FIG. 14 shows a perspective illustration of the lower housing part,

FIG. 15 shows another perspective illustration of the lower housing part,

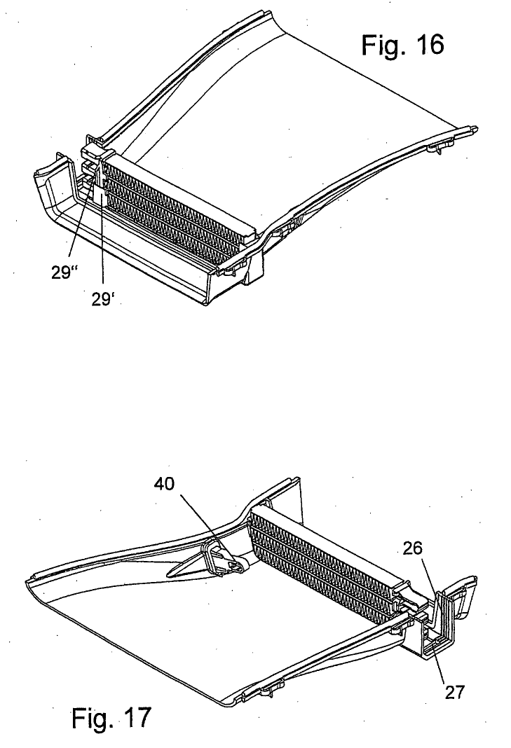

FIG. 16 shows a perspective illustration of the lower housing part with heating element,

FIG. 17 shows another perspective illustration of the lower housing part with heating element and temperature sensor,

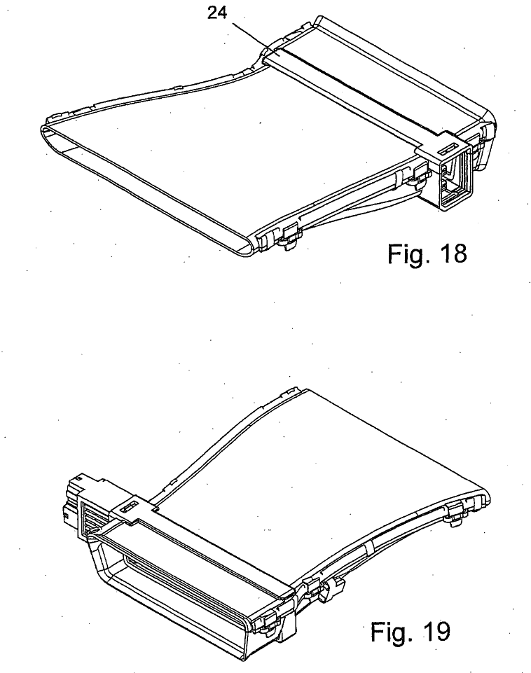

FIG. 18 shows a perspective illustration of the assembled housing,

FIG. 19 shows another perspective illustration of the assembled housing,

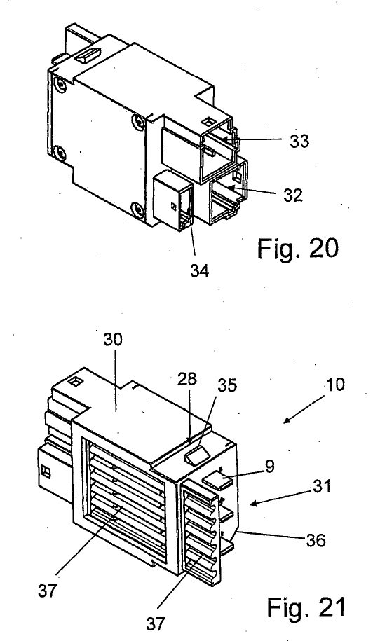

FIG. 20 shows a perspective illustration of the controller,

FIG. 21 shows another perspective illustration of the controller,

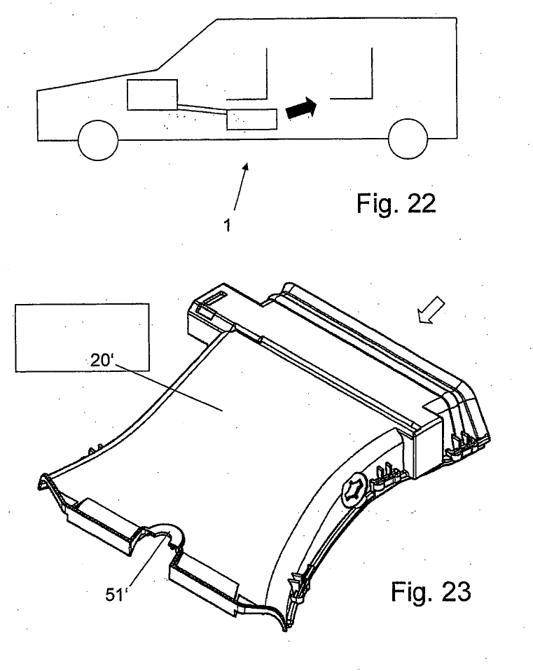

FIG. 22 shows a diagrammatic illustration of the motor vehicle with the heating arrangement,

FIG. 23 shows a perspective view of a housing lower part according to a variant from below,

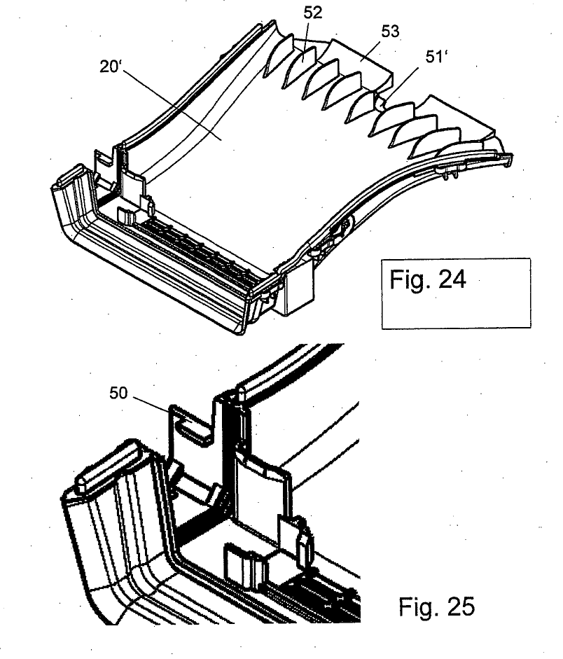

FIG. 24 shows the housing lower part of FIG. 23 obliquely from above,

FIG. 25 shows an illustration of the left region of FIG. 24 in the form of a detail,

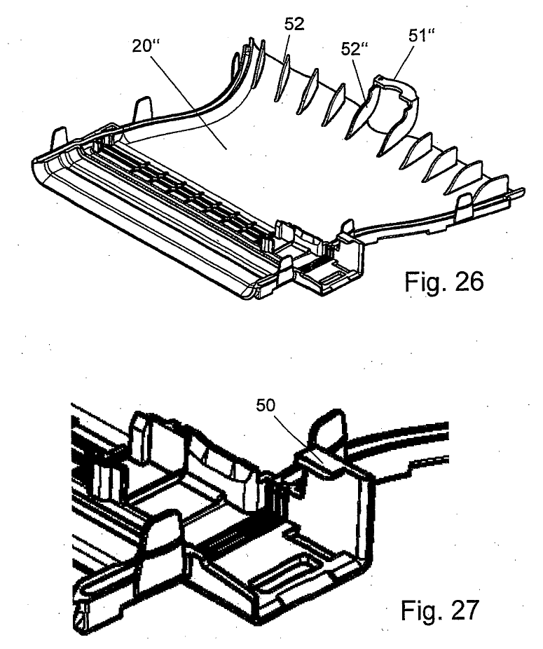

FIG. 26 shows a perspective view of a housing half of the variant of FIG. 23,

FIG. 27 shows an illustration of the lower region of FIG. 26 in the form of a detail,

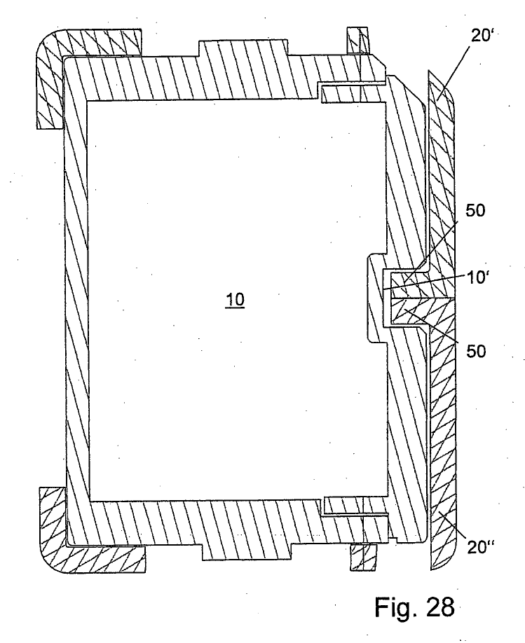

FIG. 28 shows a section through the connection region of the housing halves and the controller according to the variant of FIG. 23,

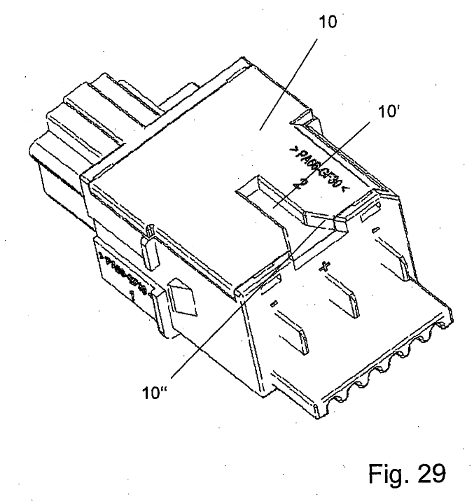

FIG. 29 shows a perspective view of the controller of FIG. 28,

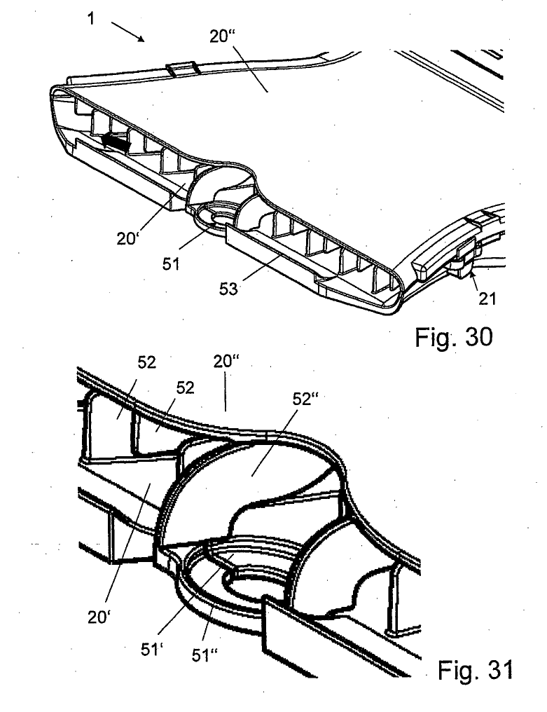

FIG. 30 shows a perspective view of the assembled housing halves according to the variant of FIG. 23, and

FIG. 31 shows a view of the fastening region of the assembled housing halves of FIG. 30 in the form of a detail.

In a PTC heating arrangement 1, serving as an interseasonal heater, of a motor vehicle. air-conditioning system having a plurality of PTC elements 3 forming an electrical heating element 2 in the form of a heating grid, the PTC elements 3 are glued in a way known per se between two contact plates 4, 4′, in the present case by means of a two-component silicone adhesive, one of the contact plates, given the reference symbol 4′ in the drawing, being elongated and of Z-shaped design and forming with its angled end part of a plug 5. The contact plate designated by the reference symbol 4 is essentially of rectangular design and is arranged parallel to the other contact plate 4′.

On those sides of the contact plates 4 and 4′ which lie in each case opposite the PTC element 3, corrugated ribs 6 are attached by means of a corresponding adhesive connection, and a further contact plate 4 and 4′ is attached in each case to these corrugated ribs, likewise again by means of a corresponding adhesive connection, these contact plates corresponding to the contact plates 4 and 4′ described above. For the simple electrical contacting of the Z-shaped contact plates 4′, at their end a contact element 7 is attached, with spring tongues 8 into which can be introduced a plug part 9, in the present case a pin of a controller 10, which is dealt with in more detail later.

To protect the contact elements 7, these are arranged in a connection piece 11 which, in the assembled state, also receives the ends of the Z-shaped contact plates 4′. In this case, the connection piece 11 has an insulating plug-part plastic housing 12 with three slot-shaped lateral orifices 13 for introducing the three electrically contacting plug parts 9 of the controller 10. Furthermore, the connection piece 11 has an insulating partition 14 which ensures that a short circuit between the contact plates 4 and 4′ is avoided. Furthermore, the connection piece 11 has a sealing-off function, so that an outflow of air through the plug connection of the plug parts 5 to the plug parts 9 of the controller 10 is prevented.

Arranged around the arrangement described above is a two-part plastic housing, designated below as an air duct housing 20, which is part of the air routing duct of the motor vehicle air-conditioning system (cf. FIG. 22). In this case, the air duct housing 20 is not divided centrally, but, instead, as is clear, for example, from FIG. 17, the housing lower part 20′ forms the largest part of the air duct region and the housing upper part 20″ is designed essentially as a cover, the edges of the cover being drawn slightly downward. The asymmetric design of the air duct housing 20 helps in avoiding assembly errors. Arrangement in the motor vehicle is, in the present case, in the region below the front row of seats, so that the heating arrangement 1 heats, as required, the air which is supplied to the second row of seats.

The two parts of the air duct housing 20 are firmly connected to one another by means of snap connections 21 and clips 22, the heating element 2 with contact elements 7, connection piece 11 and controller 10 being interposed. By the housing connections being arranged on the outside, that is to say especially the snap connections 21 and clips 22, there is no need for any fastening elements in the region of the air duct, so that no turbulences, associated with a pressure drop, of the air flowing in the air duct, etc. occur as a result of fastening elements. The snap connections 21 additionally allow positioning during mounting. As a result of its external dimensions, the housing 12 of the connection piece 11 ensures exact positioning in the air duct housing 20, so that reliable electrical contacting is possible, the contact elements 7 allowing some play with respect to the heating element 2, with the result that tolerances can be compensated, the positioning of the heating element 2 also being assisted at the same time. Furthermore, the heating element 2 is given additional hold in the assembled state.

To seal off the air duct housing 20, a kind of tongue-and-groove connection 23 is provided along the longitudinal sides of the two housing parts. In the region of the heating element 2 ribs 25 for sealing are provided in a groove-like depression 24 open on one side to the plug leadthrough and having a wall 24′ located on the air inflow side, in which the heating element 2 is arranged, for increasing the strength of the air duct housing 20 and for the spacing apart and thermal decoupling of the heating element 2 from the air duct housing 20 in each of the two housing parts. The wall 24′ prevents contact of the heating element 2 with a delivering duct (not illustrated) introduced into the air duct housing 20, said wall forming a limit stop for the delivering duct.

In the region of the lateral orifice for the plug leadthrough, a plurality of grooves 26 are formed, which serve for sealing off with respect to the controller 10 arranged in this region.

Furthermore, each housing part has provided in it, in this region with grooves 26, on the top and bottom, respectively a rectangular orifice 27 which is part of a snap connection 28 and which serves for ensuring the correct position and for fastening the controller 10 in the housing 20. Furthermore, to simplify mounting, two positioning elements. 29′ resembling a guide groove are formed on the housing 20, a slightly projecting wall region 29″ of the connection piece 11 being introduced into said positioning elements.

On the side which lies opposite the lateral orifice for the plug leadthrough, two projecting spacers 29 are formed laterally in the lower housing part 20′ and, in the assembled state, are arranged between the ends on this side of two adjacent contact plates 4 and 4′ and which prevent a short circuit between these, that is to say the function is the same as that of the abovementioned partition 14 of the connection piece 11, while they additionally have a positioning function with respect to the arrangement of the heating element 2 in the air duct housing 20.

The controller 10 has a controller housing 30. On a first side of the controller 10, a flat plug 31 is formed, with the abovementioned three electrically contacting plug parts 9 which, in the assembled state, are connected to the plug part 5 of the heating element 2. On the other side of the controller 10, the plug parts for electrical contacting and activation are formed, the plug part for the positive pole being designated by 32, that for the negative pole by 33 and that for activation by 34. According to the present exemplary embodiment, the activation of the controller 10 takes place via the activation plug 34, but a bus, for example an LIN or CAN bus, or a PWM signal (pulse width modulation) may also be provided for control.

Diagnosis in the event of a problem may also take place via the plugs. To fasten the controller 10 in the air duct housing 20, a projection 35 is formed in each case at the top and bottom, said projection being part of the snap connection 28 and, in the assembled state, being latched in the corresponding orifice 27.

The controller housing 30 has formed on it a slope 36 which, in co-operation with a corresponding projection (not illustrated) on a housing part or, if appropriate, also on the connection piece 11, prevents a twisted installation of the controller 10 (faulty-assembly prevention device). In order to allow a sufficient cooling of the controller 10, the controller 10 has provided on it a cooling plate 37 which is provided with ribs and which extends essentially outside the air duct housing 20, but also partially within the air duct in the air duct housing 20 (cf. FIG. 2), and which serves for cooling the power electronics arranged in a controller housing 30. Partial arrangement inside the air duct on the air inflow side of the heating element 2 improves the cooling capacity, especially during interseasonal heating operation, in which the greatest heat occurs in the controller 10 and in which the air is cool on the air inflow side of the heating element 2.

Furthermore, a temperature sensor 40 is arranged on one side in the air duct housing 20 downstream of the heating element 2, in the air flow direction. In this case, the temperature sensor 40 serves for a temperature regulation and increases reliability. In the present case, the temperature sensor 40 is a PTC sensor, but any other desired temperature sensor may be used, such as, for example, an NTC sensor or a thermocouple. The temperature sensor may, if appropriate, even be dispensed with entirely.

A variant of the exemplary embodiment is described below with reference to FIGS. 23 to 31, identical and identically acting components or elements being given the same reference symbols as in the exemplary embodiment described above. Furthermore, the housing 20, in so far as it is not described otherwise below, is designed correspondingly to the housing 20 according to the exemplary embodiment described above.

As illustrated in FIG. 28, the two housing parts 20′ and 20″ are held together in the region of the laterally attached controller 10 by the latter by means of a groove 10′ with an introduction slope 10″ which is formed in the controller housing (see FIG. 29), for which purpose a projection 50 projecting inward in the direction of the construction space for the controller 10 is formed on each housing part 20′, 20″. In the correctly assembled state of the housing 20, the two projections 50 lie exactly one on the other and fit with slight play in the groove 10′ in the controller housing when the controller 10 is pushed laterally into the housing region which forms the receptacle for the controller 10. The housing region forming the receptacle for the controller 10 is provided with orifices for cooling the controller 10, as is evident in FIG. 28.

To fasten the two housing parts 20′ and 20″ to the vehicle floor (floor trim or carpet) by means of a screw (not illustrated) and for simultaneously ensuring that the two housing parts 20′ and 20″ are fixed to one another in an exact position, a shackle 51 is provided which is formed by the two housing parts 20′ and 20″. In this case, a first shackle part 51′ is formed in one piece on the housing lower part 20′ and a second shackle part 51″ is formed in one piece on the housing upper part 20″, said shackle parts together forming a perforated disk, as is evident from figures 24 and 26. In this case, the housing upper part 20″ engages over the housing lower part 20′, as is evident from FIG. 31, so that, when they are being screwed down, there is automatically a visual check of the correct assembly of the housing halves. By the shackle 51 being subdivided centrally, there is a uniform force distribution to both housing parts 20′ and 20″, so that the two housing parts are pressed onto the vehicle floor by the screw with essentially the same force. The positioning and fixing of the housing parts 20′ and 20″ to one another take place by means of snap connections 21 which are provided on the housing parts and which were described above with reference to the exemplary embodiment. Since the housing upper part 20″ is drawn downward, deformations of the latter, which could arise on account of the otherwise relatively large unfixed region of the air outlet, are additionally avoided.

Furthermore, ribs 52 are formed both on the housing lower part 20′ and on the housing upper part 20″ in the region of the air outlets so as to be integrated into the housing 20. These ribs 52 are provided over the entire width of the air duct at uniform intervals. They run essentially parallel to the sides of the air duct. Moreover, the middle ribs 52″ of the housing upper part 20″ form the connection pieces to the second shackle part 51″.

The ribs 52 stiffen the housing 20, especially also in terms of pressure load from above, and, in addition to the air guide function, also have a protective function, since they prevent foreign bodies, such as paper or the like, from entering the air duct.

Furthermore, the housing lower part 20′ has formed on it two ramps 53 for routing the airstream upward, which are interrupted in the middle of the air outlet by the fastening region of the shackle 51. The ramps 53, in the present case, extend laterally as far as the penultimate outer rib 52, but may also be formed over the entire width. Alternatively, even more ribs, for example even with a different height, for example higher on the outside than in the middle, or a single continuous rib may be provided. The ramps 53 serve for deflecting the airstream upward, so that, in spite of the heating arrangement 1 being fixed to the vehicle floor, the occupants are heated more effectively.

1. An electrical heating arrangement, especially for a motor vehicle, with an air duct housing through which air to be heated flows, as required, and with an electrical heating element which is arranged in the air duct housing, wherein the electrical heating element is arranged directly in the air duct housing.

2. The electrical heating arrangement as claimed in claim 1, wherein the air duct housing is designed in at least two parts as a plastic housing in the region in which the electrical heating element is arranged.

3. The electrical heating arrangement as claimed in claim 2, wherein the two parts of the air duct housing are connected to one another by means of a snap connection and/or clips on the outside of the housing.

4. The electrical heating arrangement as claimed in claim 2, wherein the two parts of the air duct housing are designed asymmetrically.

5. The electrical heating arrangement as claimed in claim 2, wherein a kind of tongue-and-groove connection is formed between the two parts of the air duct housing.

6. The electrical heating arrangement as claimed in claim 1, wherein the electrical heating element comprises at least one PTC element.

7. The electrical heating arrangement as claimed in claim 6, wherein contact plates are attached on both sides of the PTC element.

8. The electrical heating arrangement as claimed in claim 6, wherein the PTC element is attached to a contact plate by means of an adhesive connection.

9. The electrical heating arrangement as claimed in claim 6, wherein a corrugated rib is attached by means of an adhesive connection to that side of the contact plate which faces away from the PTC element.

10. The electrical heating arrangement as claimed in claim 6, wherein a further contact plate is attached to the corrugated rib by means of an adhesive connection on that side of the corrugated rib which faces away from the PTC element.

11. The electrical heating arrangement as claimed in claim 6, wherein at least two contact plates are designed in such a way that they are designed at one end as part of a plug.

12. The electrical heating arrangement as claimed in claim 11, wherein the contact plates are of Z-shaped design.

13. The electrical heating arrangement as claimed in claim 6, wherein an adhesive connection between the PTC element and contact plate and/or the contact plate and corrugated rib is formed via a two-component silicone adhesive.

14. The electrical heating arrangement as claimed in claim 1, wherein a connection piece with an insulating housing is arranged in the air duct housing.

15. The electrical heating arrangement as claimed in claim 1, wherein at least one positioning element resembling a guide groove is formed on the housing, a slightly projecting wall region of the connection piece being capable of being introduced into said positioning element.

16. The electrical heating arrangement as claimed in claim 14, wherein the housing has an insulating partition which ensures that a short-circuit is avoided.

17. The electrical heating arrangement as claimed in claim 1, wherein at least one spacer is formed on the air duct housing and ensures that a short-circuit within the electrical heating element is avoided.

18. The electrical heating arrangement as claimed in claim 1, wherein a controller for the electrical activation of the electrical heating element is provided.

19. The electrical heating arrangement as claimed in claim 18, wherein the controller is arranged laterally on the heating element.

20. The electrical heating arrangement as claimed in claim 18, wherein the controller has a cooling plate which projects at least partially into the air duct housing.

21. The electrical heating arrangement as claimed in claim 1, wherein a temperature sensor is arranged downstream of the heating element in the air duct formed by the air duct housing.
